(19) United States
(12) Patent Application Publication
(10) Pub. No.: US 2023/0241911 A1
(43) Pub. Date: Aug. 3, 2023

(54) PAINT BRUSH HOLDING APPARATUS

(71) Applicant: Imagine The Solution LLC, Detroit, MI (US)

(72) Inventor: Rene Torres, Saginaw, MI (US)

(73) Assignee: Imagine The Solution, LLC, Detroit, MI (US)

(21) Appl. No.: 18/104,572

(22) Filed: Feb. 1, 2023

Related U.S. Application Data
(60) Provisional application No. 63/306,026, filed on Feb. 2, 2022.
(60) Provisional application No. 63/306,030, filed on Feb. 2, 2022.

(51) Int. Cl. B44D 3/12

(52) U.S. Cl. CPC B44D 3/123; B44D 3/126

(57) ABSTRACT

A paintbrush holding apparatus for a paint tray that includes a trough. A brush holding body is attached to the trough. The brush holding body includes an inner portion separated from an outer portion. The inner portion includes a magnetic portion formed thereon. The magnetic portion is structured to hold a ferrule of a brush and maintain the paintbrush above or within the tray. The outer portion includes a magnetic portion formed thereon. The magnetic portion is structured to hold a ferrule of a brush and maintain the paintbrush above or within the trough. An attachment structure is attached to the brush holding body. The attachment structure grasps a wall of the paint tray. The brush holding body is positioned within a volume of the paint tray and the trough is positioned outboard of the volume of the paint tray.

### CROSS-REFERENCE TO RELATED APPLICATIONS

This application claims priority of U.S. Provisional Application No. 63/306,026 filed Feb. 2, 2022 and U.S. Provisional Application No. 63/306,030 filed Feb. 2, 2022 the contents of which are incorporated herein by reference.

### FIELD OF THE INVENTION

The instant application is directed to a paintbrush holding apparatus.

### BACKGROUND OF THE INVENTION

Generally, when a painter is painting with both paintbrushes and a roller in the paint tray more than likely one of the tools will end up in the tray while the other is being used. Sometimes the painter is painting with two different size paintbrushes at once to cut in different corners and paint around edges. When the paintbrushes are not the tool being utilized, they are often laid in the paint tray and eventually fall in the paint getting covered in paint. This results in wasted time cleaning the tool and potentially resulting in messy painting conditions.

Accordingly, a paintbrush holding structure that attaches to a tray and provides a separate holding structure is desirable. Further, there is a need in the art for a paintbrush holding structure that is positioned outboard of the paint tray.

### SUMMARY OF THE INVENTION

In one aspect, there is disclosed a paintbrush holding apparatus for a paint tray that includes a brush holding body. A trough is attached to the brush holding body. An attachment structure is attached to the brush holding body. The attachment structure grasps a wall of the paint tray. The brush holding body is positioned within a volume of the paint tray and the trough is positioned outboard of the volume of the paint tray.

In another aspect, there is disclosed a paintbrush holding apparatus for a paint tray that includes a trough. A brush holding body is attached to the trough. The brush holding body includes an inner portion separated from an outer portion. The inner portion includes a magnetic portion formed thereon. The magnetic portion is structured to hold a ferrule of a brush and maintain the paintbrush above or within the tray. The outer portion includes a magnetic portion formed thereon. The magnetic portion is structured to hold a ferrule of a brush and maintain the paintbrush above or within the trough. An attachment structure is attached to the brush holding body. The attachment structure grasps a wall of the paint tray. The brush holding body is positioned within a volume of the paint tray and the trough is positioned outboard of the volume of the paint tray.

In a further aspect, there is disclosed a paintbrush holding apparatus for a paint tray that includes a trough. A brush holding body is attached to the trough. The brush holding body includes an inner portion separated from an outer portion. The inner portion includes inner and outer surfaces. The outer surface includes an attachment structure formed or attached thereon. The attachment structure includes a holding tang having a body that extends from the outer surface and then curves at a radius to define a spring clip. The attachment structure grasps a wall of the paint tray. The brush holding body is positioned within a volume of the paint tray and the trough is positioned outboard of the volume of the paint tray.

### BRIEF DESCRIPTION OF THE DRAWINGS

FIG. 1 is a perspective view of one embodiment of a paintbrush holding structure attached to a paint tray;

FIG. 2 is a perspective view of one embodiment of a paintbrush holding structure of FIG. 1;

FIG. 3 is a top view of another embodiment of a paintbrush holding structure attached to a paint tray;

FIG. 4 is a perspective view of another embodiment of a paintbrush holding structure attached to a paint tray;

FIG. 5 is a back view of another embodiment of a paintbrush holding structure; of FIG. 4;

FIG. 6 is a side perspective of another embodiment of a paintbrush holding structure; of FIG. 4;

FIG. 7 is a top perspective view of another embodiment of a paintbrush holding structure of FIG. 4;

FIG. 8 is a top perspective view of another embodiment of a paintbrush holding structure;

FIG. 9 is a side perspective view of another embodiment of a paintbrush holding structure of FIG. 8;

FIG. 10 is a front view of another embodiment of a paintbrush holding structure of FIG. 8.

### DETAILED DESCRIPTION OF THE EMBODIMENTS

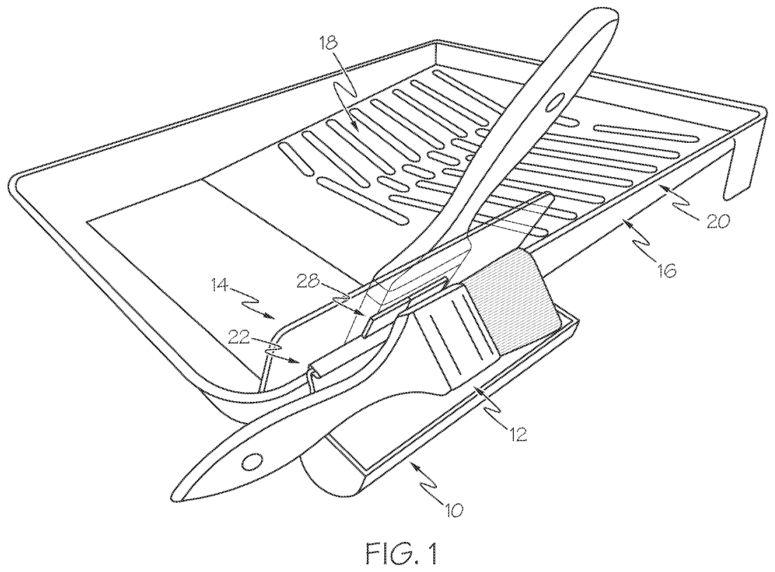

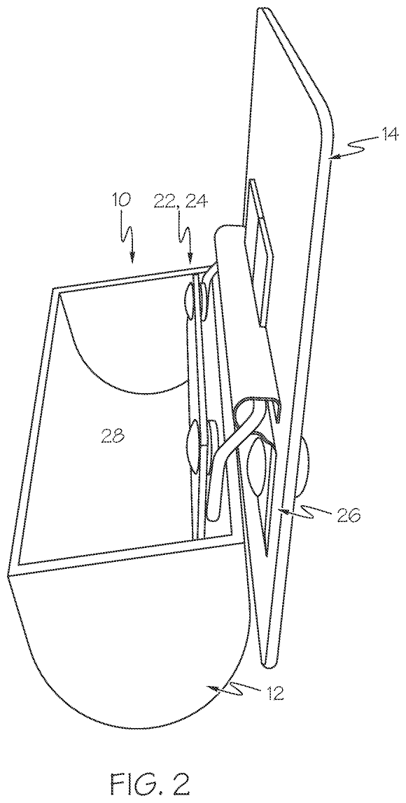

Referring to FIGS. 1 and 2, there is shown one embodiment of a paintbrush holding apparatus 10. In the depicted embodiment, the paintbrush holding apparatus 10 includes a paint trough 12 attached to a brush holding body 14. The brush holding body 14 may be positioned within a paint tray 16. The trough 12 may have various lengths and widths to be attached to various sized trays 16.

The tray 16 includes a base surface 18 having a plurality of upstanding walls 20 that are joined to define a volume of the paint tray 16. In one aspect, the term upstanding walls 20 may also include the walls of a liner that may be positioned in the paint tray 16.

The brush holding body 14 includes an attachment structure 22 attached thereon. The attachment structure includes a clamping structure 24 having two separate halves 26 that grasp a wall 20 of the paint tray 16 as shown in FIG. 1. It should be realized that various numbers of paintbrush holding apparatus 10 may be attached to the paint tray 16.

The brush holding body 14 includes a magnetic portion 28 formed or attached thereon. The magnetic portion 28 magnetically grasps the ferrule of a paintbrush. The magnetic portion 28 is structured to hold the ferrule of the brush and maintain the paintbrush out of the paint within the paint tray 16.

Additionally, the magnetic portion 28 may hold the brush outside of the paint tray 16 and above or within the trough, as shown in FIG. 1. The trough 12 may catch any potential residual paint on the brush. Alternatively, the trough 12 may receive paint and the brush may be used with the paint contained in the trough 12.

In use, a person may attach the paintbrush holding apparatus 10 to a wall 20 of the paint tray 16. The attachment structure 22 is locked such that the clamps securely grasp the wall 20 of the tray 16. As stated above, wall may include a liner that is positioned in the tray. In such a case, the liner may be securely clamped as well between the tray 16 and the clamps. The brush holding body 14 is positioned in the inner volume of the paint tray 16. The trough 12 is positioned outboard of the paint tray 16. The magnetic portion 28 may hold a paintbrush above or within the tray 16 or above or within the trough 12.

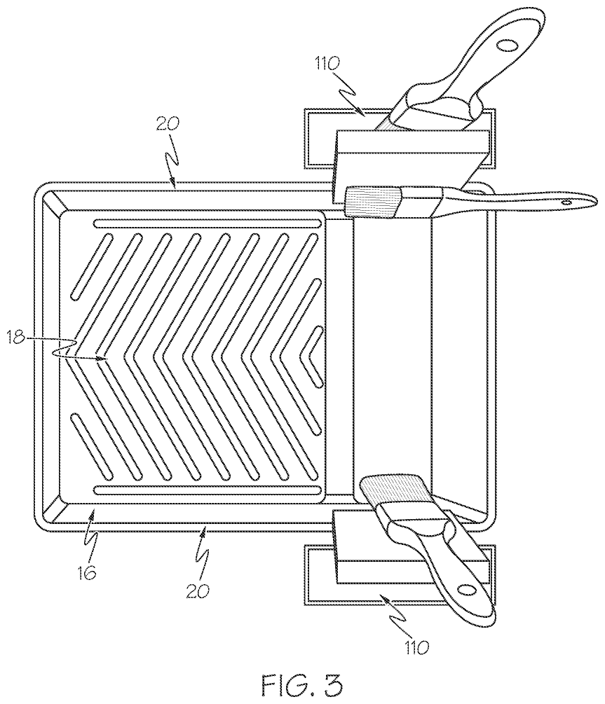

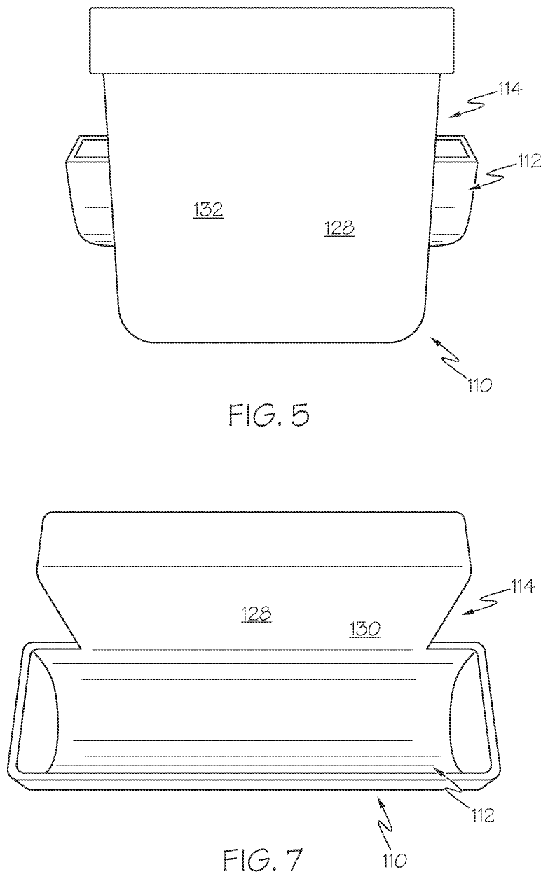

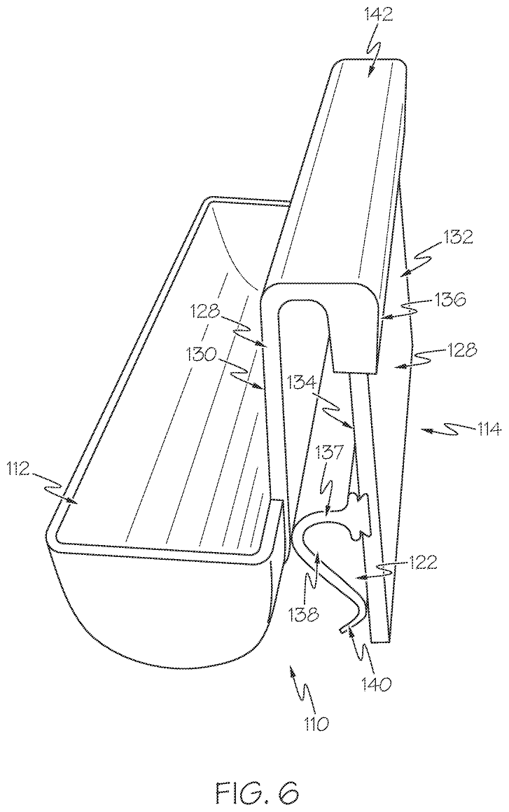

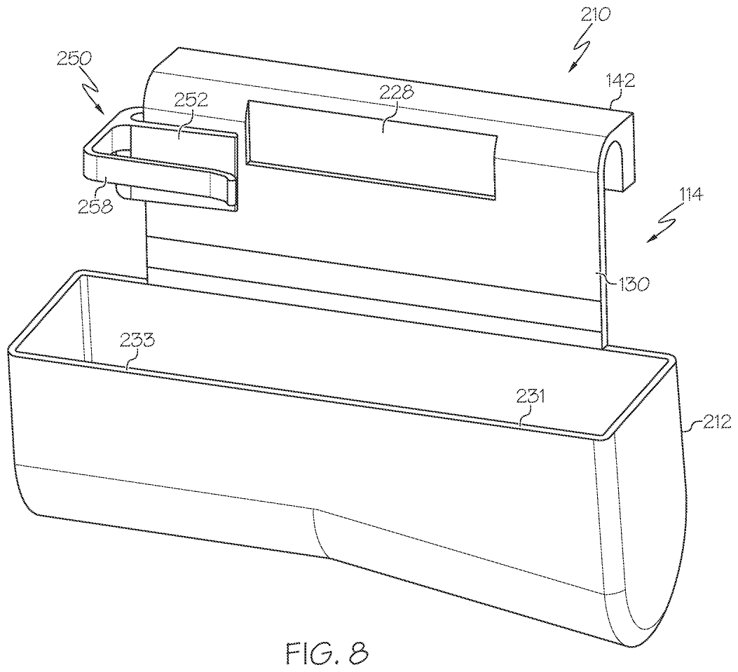

Referring to FIGS. 3-7, there is shown another embodiment of the paintbrush holding apparatus 110. In the depicted embodiment, the paintbrush holding apparatus 110 includes a paint trough 112 coupled or formed with a brush holding body 114. The trough 112 may have various lengths and widths to be attached to various sized trays 16.

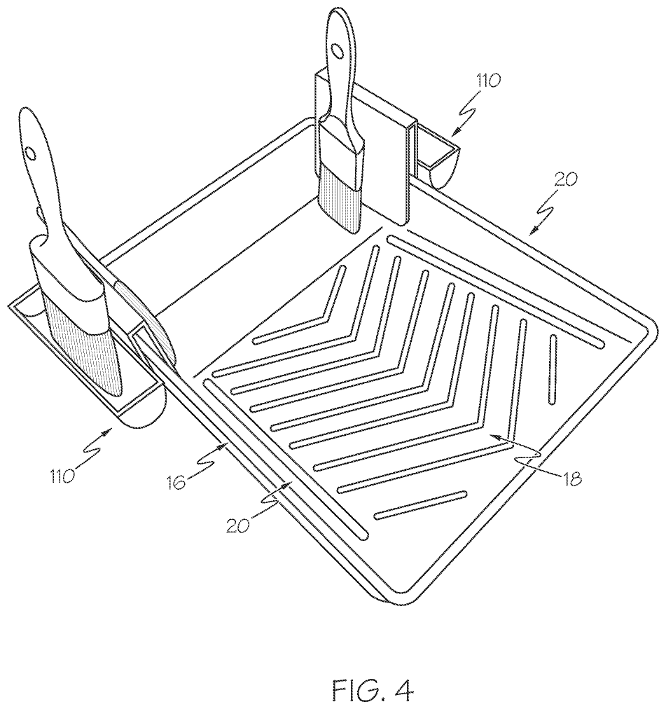

The brush holding body 114 may include an inner portion 130 separated from an outer portion 132. The outer portion 132 is positioned within a boundary or inner volume of the tray 16. The outer portion 132 includes inner and outer surfaces 134, 136. The inner surface 134 includes an attachment structure 122 formed or attached thereon. The attachment structure 122 may include a holding tang 138 having a body 140 that extends from the outer surface 136 and then curves at a radius 137 to define a spring clip 140. The spring clip 140 flexes at the radius 137 to securely grasp the wall 20 of the tray 16, as shown in FIGS. 3 and 4. As stated above, the wall 20 may include a liner that is positioned in the tray. In such a case, the liner may be securely grasped as well between the tray 16 and the spring clip 140.

The brush holding body 114 includes an outer portion 132 joined and separated from the inner portion 130 by a coupler 142. The inner portion 130 includes the trough 112 attached or formed thereon.

The brush holding body 114 includes a magnetic portion 128 formed or attached thereon on both the inner and outer portions 130, 132. The magnetic portion 128 magnetically grasps the ferrule of a paintbrush. The magnetic portion 128 is structured to hold the ferrule of the brush and maintain the paintbrush out of the paint within the paint tray 16.

Additionally, the magnetic portion 128 may hold the brush outside of the paint tray 16 and above or within the trough 112, as shown in FIGS. 3 and 4. The trough 112 may catch any potential residual paint on the brush. Alternatively, the trough 112 may receive paint and the brush may be used with the paint contained in the trough.

In use, a person may attach the paintbrush holding apparatus 110 to a wall 20 of the paint tray 16. The wall 20 of the tray 16 is positioned in the spring clip 140 and securely grasps the wall 20 of the tray 16. The brush holding body 114 is positioned in the inner volume of the paint tray 16. The trough 112 is positioned outboard of the paint tray 16. The magnetic portion 128 may hold a paintbrush above or within the tray 16 or above or within the trough 112.

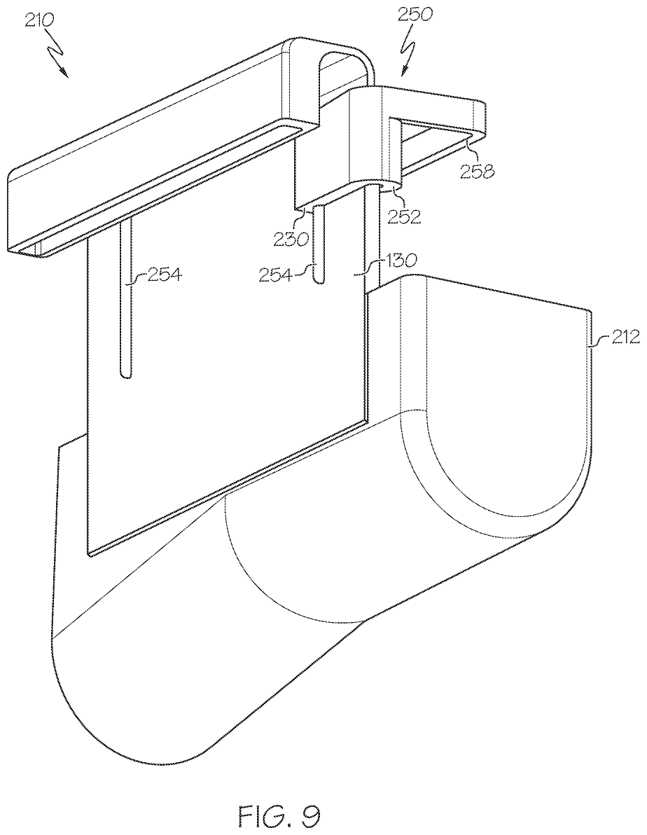

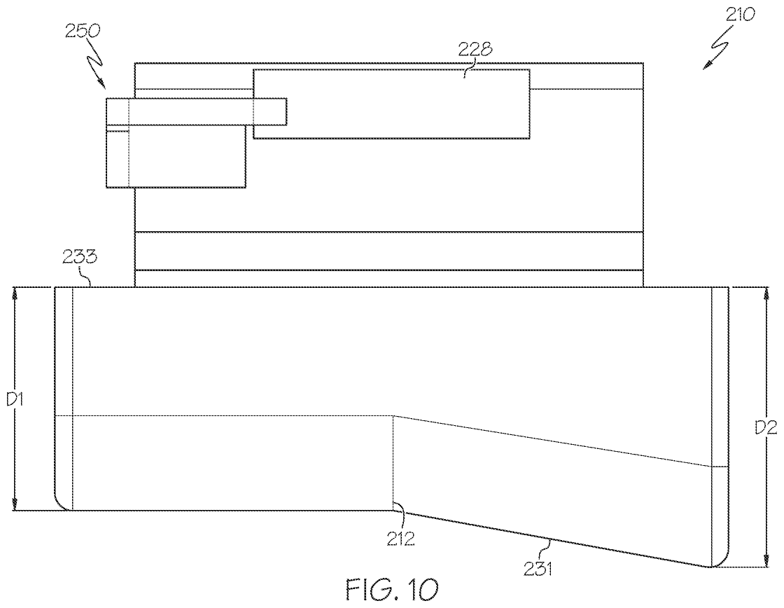

Referring to FIGS. 8-10, there is shown another embodiment of the paintbrush holding apparatus 210. In the depicted embodiment, the paintbrush holding apparatus 210 includes a paint trough 212 coupled or formed with a brush holding body 114. The trough 212 may have various lengths and widths to be attached to various sized trays 16. In one aspect, the trough may include an angled portion 231 formed thereon. The angled portion 231 may have a deeper depth D2 relative to a depth D1 of the non-angled portion 233 of the trough 212. The angled portion 231 may be used to accommodate angled paint brushes. It should be realized that the trough 212 may also be utilized to hold a paint roller.

The brush holding body 114 may include an inner portion 130 separated from an outer portion 232. The outer portion 132 is positioned within a boundary or inner volume of the tray 16. The outer portion 132 includes inner and outer surfaces 134, 136 (best seen above). In the depicted embodiments, the outer portion 132 including an attachment structure 122 as described above and is removed for clarity in FIGS. 8-10. The attachment structure 122 is the same as that described above with reference to FIGS. 3-7. The brush holding body 114 includes an outer portion 132 joined and separated from the inner portion 130 by a coupler 142. The inner portion 130 includes the trough 212 attached or formed thereon.

The brush holding body 114 includes a magnetic portion 228 formed or attached thereon on both the inner and outer portions 130, 132 as described above. The magnetic portion 228 magnetically grasps the ferrule of a paintbrush. The magnetic portion 228 is structured to hold the ferrule of the brush and maintain the paintbrush out of the paint within the paint tray 16.

Additionally, the magnetic portion 228 may hold the brush outside of the paint tray 16 and above or within the trough 212. The trough 212 may catch any potential residual paint on the brush. Alternatively, the trough 212 may receive paint and the brush may be used with the paint contained in the trough.

In the depicted embodiment, a brush clip 250 may be attached to the inner portion 130. Various numbers of clips 250 may be attached on different sides of the inner portion 130. The brush clip 250 may include a generally U-shaped attachment portion 252 that receives the inner portion 130. The back surface of the inner portion 130 may include beads 254 formed thereon on opposing sides of the inner portion 130. The beads 254 are received in notches 256 formed in the generally U-shaped attachment portion 252. The clips 250 also include a grip portion 258 formed thereon. The grip portion 258 may grasp a handle of a paintbrush.

In use, a person may attach the paintbrush holding apparatus 210 to a wall 20 of the paint tray 16. The wall 20 of the tray 16 is positioned in the spring clip 140 and securely grasps the wall 20 of the tray 16. The brush holding body 114 is positioned in the inner volume of the paint tray 16. The trough 212 is positioned outboard of the paint tray 16. The magnetic portion 228 may hold a paintbrush above or within the tray 16 or above or within the trough 212.

I claim:

1. A paintbrush holding apparatus for a paint tray comprising:
a brush holding body;
a trough attached to the brush holding body;
an attachment structure attached to the brush holding body, the attachment structure grasping a wall of the paint tray, wherein the brush holding body is positioned within a volume of the paint tray and the trough is positioned outboard of the volume of the paint tray.

2. The paintbrush holding apparatus for a paint tray of claim 1 wherein the brush holding body includes a magnetic portion formed thereon, the magnetic portion structured to hold a ferrule of a brush and maintain the paintbrush out of paint within the paint tray.

3. The paintbrush holding apparatus for a paint tray of claim 1 wherein the brush holding body includes a magnetic portion formed thereon, the magnetic portion structured to hold a ferrule of a brush and maintain the paintbrush above or within the trough.

4. The paintbrush holding apparatus for a paint tray of claim 1 wherein the attachment structure includes a clamping structure having two separate halves that grasp a wall of the paint tray.

5. The paintbrush holding apparatus for a paint tray of claim 1 wherein the brush holding body includes an inner portion separated from an outer portion.

6. The paintbrush holding apparatus for a paint tray of claim 5 wherein the inner portion is positioned within an inner volume of the tray.

7. The paintbrush holding apparatus for a paint tray of claim 5 wherein the inner portion includes inner and outer surfaces, the outer surface includes an attachment structure formed or attached thereon.

8. The paintbrush holding apparatus for a paint tray of claim 7 wherein the attachment structure includes a holding tang having a body that extends from the outer surface and then curves at a radius to define a spring clip.

9. The paintbrush holding apparatus for a paint tray of claim 5 wherein the brush holding body includes an outer portion joined and separated from the inner portion by a coupler, the outer portion including the trough attached or formed thereon.

10. The paintbrush holding apparatus for a paint tray of claim 5 wherein inner portion includes a magnetic portion formed thereon, the magnetic portion structured to hold a ferrule of a brush and maintain the paintbrush above or within the tray.

11. The paintbrush holding apparatus for a paint tray of claim 5 wherein outer portion includes a magnetic portion formed thereon, the magnetic portion structured to hold a ferrule of a brush and maintain the paintbrush above or within the trough.

12. A paintbrush holding apparatus for a paint tray comprising:
a trough;
a brush holding body attached to the trough, the brush holding body includes an inner portion separated from an outer portion, wherein inner portion includes a magnetic portion formed thereon, the magnetic portion structured to hold a ferrule of a brush and maintain the paintbrush above or within the tray and wherein the outer portion includes a magnetic portion formed thereon, the magnetic portion structured to hold a ferrule of a brush and maintain the paintbrush above or within the trough.
an attachment structure attached to the brush holding body, the attachment structure grasping a wall of the paint tray, wherein the brush holding body is positioned within a volume of the paint tray and the trough is positioned outboard of the volume of the paint tray.

13. The paintbrush holding apparatus for a paint tray of claim 12 wherein the inner portion includes inner and outer surfaces, the outer surface includes an attachment structure formed or attached thereon.

14. The paintbrush holding apparatus for a paint tray of claim 13 wherein the attachment structure includes a holding tang having a body that extends from the outer surface and then curves at a radius to define a spring clip.

15. The paintbrush holding apparatus for a paint tray of claim 12 wherein the brush holding body includes an outer portion joined and separated from the inner portion by a coupler, the outer portion including the trough attached or formed thereon.

16. A paintbrush holding apparatus for a paint tray comprising:
a trough;
a brush holding body attached to the trough, the brush holding body includes an inner portion separated from an outer portion, wherein the inner portion includes inner and outer surfaces, the outer surface includes an attachment structure formed or attached thereon, the attachment structure includes a holding tang having a body that extends from the outer surface and then curves at a radius to define a spring clip, the attachment structure grasping a wall of the paint tray, wherein the brush holding body is positioned within a volume of the paint tray and the trough is positioned outboard of the volume of the paint tray.

17. The paintbrush holding apparatus for a paint tray of claim 16 wherein the brush holding body includes an outer portion joined and separated from the inner portion by a coupler, the outer portion including the trough attached or formed thereon.

18. The paintbrush holding apparatus for a paint tray of claim 16 wherein inner portion includes a magnetic portion formed thereon, the magnetic portion structured to hold a ferrule of a brush and maintain the paintbrush above or within the tray.

19. The paintbrush holding apparatus for a paint tray of claim 16 wherein outer portion includes a magnetic portion formed thereon, the magnetic portion structured to hold a ferrule of a brush and maintain the paintbrush above or within the trough.

20. The paintbrush holding apparatus for a paint tray of claim 16 wherein the trough includes an angled portion and a non-angled portion.

21. The paintbrush holding apparatus for a paint tray of claim 20 wherein the angled portion has a depth greater than the non-angled portion.

22. The paintbrush holding apparatus for a paint tray of claim 16 further including at least one clip attached to the inner portion of the brush holding body.

23. The paintbrush holding apparatus for a paint tray of claim 22 wherein the at least one clip includes include a generally U-shaped attachment portion that receives the inner portion and a back surface of the inner portion includes beads formed thereon on opposing sides of the inner portion, the beads are received in notches formed in the generally U-shaped attachment portion.

24. The paintbrush holding apparatus for a paint tray of claim 23 wherein the at least one clip includes a grip portion formed thereon grasping a handle of a paintbrush.
